(19) United States
(12) Patent Application Publication
(10) Pub. No.: US 2017/0193369 A1
(43) Pub. Date: Jul. 6, 2017

(54) ASSISTIVE COMMUNICATION SYSTEM AND METHOD

(71) Applicant: Midtown Doornail, Inc., Fort Lauderdale, FL (US)

(72) Inventors: William Ferrell, Fort Lauderdale, FL (US); Jared Kopf, Fort Lauderdale, FL (US)

(73) Assignee: Midtown Doornail, Inc., Fort Lauderdale, FL (US)

(21) Appl. No.: 15/400,829

(22) Filed: Jan. 6, 2017

Related U.S. Application Data
(60) Provisional application No. 62/275,406, filed on Jan. 6, 2016.

(51) Int. Cl. G06N 5/02; G06F 9/44; G06F 17/28

(52) U.S. Cl. CPC G06N 5/022; G06F 17/28; G06F 8/30

(57) ABSTRACT

Systems and methods for providing an assistive communication layer includes receiving a communication and/or data input from one or more users and/or one or more non-users; establishing an interaction session between the one or more users and/or one or more non-users and the assistive communication layer based on the communication and/or data input from the one or more users and/or one or more non-users; analyzing the communication and/or data input from the one or more users and/or one or more non-users; and responsive to the analysis of the communication and/or data input, (i) referencing a knowledge database for data relevant to the analysis and (ii) identifying one of a plurality of operational protocols to execute.

### CROSS-REFERENCE TO RELATED APPLICATIONS

This application claims the benefit of U.S. Provisional Application No. 62/275,406, filed 6 Jan. 2016, which is incorporated in its entirety by this reference.

### TECHNICAL FIELD

This invention relates generally to the assistive communication field, and more specifically to a new and useful assistive communication and work performance field.

### BACKGROUND

Modern day technology can be helpful in accomplishing everyday tasks at home and in the workplace. People generally seek assistive technologies, such as mobile phone applications or physical machines or robots, which can help reduce their workload. However, many of these applications and machines, while helpful in some cases, do not always relieve the users of the many tasks that the users face every day and cannot effectively relieve the users of the mental space and time spent performing the work associated with these everyday tasks.

Thus, there is a need in the assistive communication and work performance field for a new and useful assistive communication systems and methods.

The inventions of the present application provide such new and useful systems and methods.

### BRIEF DESCRIPTION OF THE FIGURES

FIG. 1 illustrates a schematic of a system of one or more embodiments of the present application;

FIG. 2 illustrates a process flow of a method of one or more embodiments of the present application; and

FIG. 3 illustrates a process flow of a method of one or more embodiments of the present application.

### DESCRIPTION OF THE PREFERRED EMBODIMENTS

The following description of the preferred embodiments of the present application is not intended to limit the inventions herein to these preferred embodiments, but rather to enable any person skilled in the art to make and use these inventions.

### Overview

This system preferably includes a platform on which developers can leverage the assistive communication system to build software (agents) that are able to take on work from users, trigger work automatically, call other agents according to rich context, acquire knowledge from humans through multi-channel knowledge acquisition units. The acquisition of knowledge from a user, a group of humans (users and or non-users) or third parties can happen immediately, delayed, just-in-time—picking between these modalities as determined to be optimal by the assistive communication system. Further, users can train or control the assistive communication system to acquire knowledge or trigger a task at a given time or when a set of given conditions are met. Knowledge is also gathered from APIs and databases of public and private knowledge. The assistive communication system aids in identifying the correct knowledge base, and can learn in interacting with individual users or in aggregate across users to improve its capabilities.

Further, the systems, methods, and computer program products disclosed herein when used separately and together allow for intelligent machines—machines that proactively work for people—to solve tasks, help people discover new opportunities, new solutions and new information and enable people to interact with the intelligent machines through multiple channels such as a commandable browser or communication interface. The machines provide their intelligence by leveraging the context that they develop—learning from how each individual user interacts with the machines, asking questions to learn more about each user or group of users, and using the collective intelligence to provide solutions to each individual user and/or non-user of the platform—from knowledge gained in the group. In one embodiment, an interfacing tool for interacting with the user, a commandable browser, is a set of smart keyboards and smart buttons—buttons that transform to the context of the user and provide opportunities and optionality as to the next step the user or users need to take—and simplify taking that step to a single action. This is accomplished by the machine anticipating the user's next step from a variety of signals (for example: location, time of day, email data, calendar data, natural language conversations with colleague, friends, acquaintances, and the like and a robot, historical patterns based on these signals). The systems and methods involving the smart keyboards and smart buttons are applicable mainly to the embodiments disclosed herein—and to the developer network associated with the platform.

At the outset, educating users on how to use the assistive communication may be complex but may be necessary for implementing the assistive communication system (ACS) effectively. Accordingly, through progressive disclosure (i.e. not overloading new users with too many questions) and the ACS being self-documenting/explaining itself, the ACS aids users in adopting the ACS and handing over more work to the ACS. In this regard, the ACS is able to measure the complexity of the user based on data acquired during its interactions with the user and scale or adjust the complexity of questions, number of questions, and recommendations to the user about the capabilities and functionality of the ACS.

The assistive communication system can work across multiple communication channels, selecting the appropriate channel for each piece of communication—and can use multiple channels in reaching out to a user. The ACS is a central source of knowledge that can take a given set of conditions (one of which might be the set of users to contact to accomplish a task) and the ACS will know how best to reach these individuals, will keep on top of the work/task and continue solving—providing status updates but importantly being the system that the user can rely on.

Accordingly, when a user begins using the assistive communication system, the user goes through a nominal onboarding process. During the onboarding process, the system gathers information from the user such as their phone number and name. After gathering basic information, the system optionally walks the user through a discovery process to help the user discover what the agents can do for the user. This process is more of an educational flow and a system designed to help the user get into a successful interaction with the assistive communication system agent such that the ACS provides assistance that this particular user values.

1. A System Implementing an Assistive Communication Layer

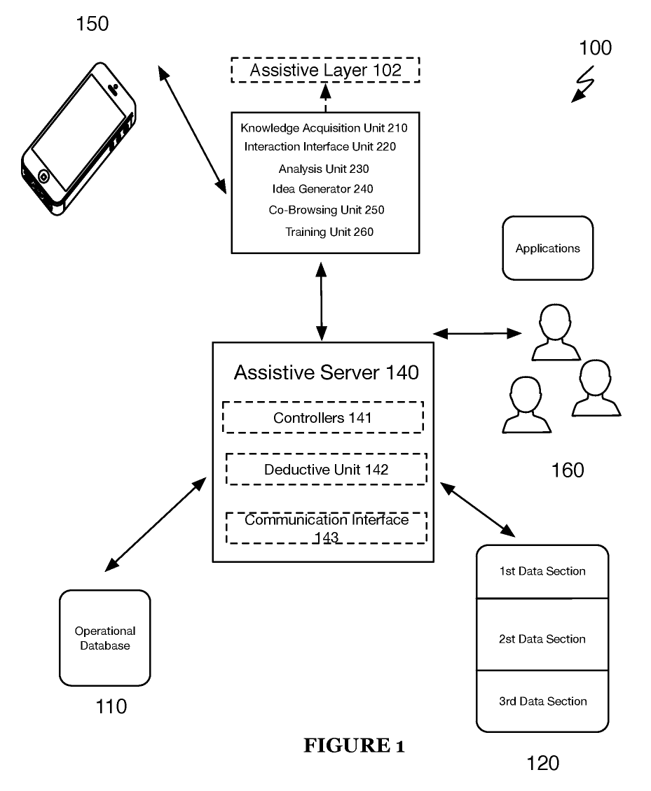

As shown in FIG. 1, an assistive communication system 100 for implementing an assistive communication layer 102 is illustrated. The system 100 includes an operational protocol database 110, a knowledge database 120, an assistive communication layer 102, an assistive communication server 140, a client computing device 150, and an assistive community 160.

The assistive communication system 100 functions to implement the assistive communication layer 102 to intelligently assist one or more users of the system 100 accomplish various tasks or work functions. The assistive communication layer 102 of system 100 can acquire relevant data about one or more users and/or non-users of the system 100 and identify contextual or circumstantial data regarding the one or more users and/or non-users to accurately provide helpful suggestions/recommendations, generate ideas for tasks or events, and perform one or more work functions and/or task, and in some instances, without any human intervention.

The assistive communication layer 102, in a preferred embodiment, may be implemented by the assistive communication server 140. Additionally, or alternatively, the assistive communication layer 102 may be implemented via the client computing device 150. The assistive communication layer 102 may include a combination of working or processing elements (e.g., central processing units (CPU), controllers, other known processing circuits, and the like) used in accomplishing various work functions of the assistive communication layer 102.

Preferably, the assistive communication layer 102 includes a knowledge acquisition unit 210, interaction interface unit 220, an analysis unit 230, an idea generator 240, a co-browsing unit 250, and a training unit 260.

The assistive communication layer 102 generally functions to interact with entities including, but not limited to, one or more users and/or one or more non-users to complete tasks and/or perform work functions. The assistive communication layer 102 may be embodied in any form, including an animated graphical interface object (e.g., an assistive agent, and the like) that can actively interact with a user and/or non-user. In other instances, the assistive communication layer 102 may be formless. For example, the assistive communication layer 102 may be implemented via a voice interface or text interface.

In some embodiments, the assistive communication layer 102 is a primary point of interaction with users and/or non-users; however, in the assistive communication system 100 and other similar assistive communication systems, there may be a number of related additional assistive communication layers that perform various functions different from the primary assistive communication layer 102. A user of the system 100 may be able to selectively use these other assistive communication layers and/or if certain conditions are met, one or more of the additional assistive communication layers may initiate an interaction with the user.

As a first example, a second assistive communication layer may be configured to provide assistance to a user of the system 100 for determining which of the one or more predetermined capabilities of the assistive communication layer 102 or other assistive communication layers that the user should utilize and generally, enables interfacing with the other assistive communication layers of the assistive communication system 100.

This second assistive communication layer may function as a chief of staff component of the assistive communication system that is continually seeking to improve the user/computer interaction and is intended to ensure the user is optimizing the assistive communication system 100. Accordingly, the chief of staff may be a channel through which the assistive communication system 100 gains more knowledge (e.g., by using the knowledge acquisition unit), and through which the chief of staff is able to lead to better overall personalization of the assistive communication system 100 while also aiding the user discover the many capabilities of the assistive communication system 100 and associated assistive communication layers that best suit the needs of the user.

As an example, for a particular user of the assistive communication layer, if the second assistive communication layer, acting as chief of staff, learns that the user has a young child, the chief of staff may identify a set of capabilities of the assistive communication layer 102 or other assistive communication layer that may be helpful in performing tasks or work associated with the user's young child (e.g., setting a bedtime, reading a bed time story, and the like).

Another assistive communication layer or a third assistive communication layer (e.g., a feature finding feedback agent) may function to collect, from one or more data sources, one or more requirements and/or concepts for additional capabilities for a new or existing assistive communication layer to be generated. The third assistive communication layer may identify unmet needs of a user and/or may crowd sourced from other users and/or non-users of the assistive communication system 100 features and capabilities for a new type of assistive communication layer that does not exist. In this regard, the third assistive communication layer aggregates suggestions and recommendations thereby fostering the generation of a new assistive communication layer having the suggested and/or desired features. In this way, the third assistive communication layer functions to continually augment the assistive communication system 100 with many helpful assistive communication layers that encourage users and non-users to meaningfully engage the system by using the existing and new assistive communication layers.

Additionally, the assistive communication layer 102 functions to identify contextual parameters and/or data based on the data in the knowledge database no and/or data newly acquired by the knowledge acquisition unit 210. Preferably, the contextual parameters define circumstances of the one or more users and/or non-users of the assistive communication system 100 that is useable to automatically identify one or more operational protocols of the assistive communication layer to be executed and/or ideas to be generated by an idea generator. The contextual parameters generally relate to a streaming set of facts with varying degrees of permanency (e.g., time, location, current calendar events, recent messages (text or email), and the like). Thus, these contextual parameters and/or data regarding the circumstances of a user are primarily temporal in nature and typically relate to circumstances occurring or relating to a present day (e.g., today) or near future of a user and in some cases, may even be limited to events, settings, or circumstances surrounding a user at a present time within minutes (e.g., 1-60 minutes) or within hours (e.g., 1-24 hours).

As mentioned above, identifying contextual parameters and/or data regarding the circumstances of a user is helpful in idea generation in which an idea generator uses the contextual data regarding a user to limit and/or constrain data and operational protocols that are considered when processing a new idea or suggestion for the user.

Additionally, or alternatively, the assistive communication layer 102 further identifies one or more patterns relating to one or more interaction methods of the one or more users and/or one or more non-users of the assistive communication system. As an example, the assistive communication layer 102 analyzing data in the knowledge database may recognize that every Tuesday (or any one particular day of the week) a user normally requests that the assistive communication layer arrange a meeting between the user and another user and/or non-user. Recognizing this pattern the assistive communication layer 102 could identify a protocol and prompt the user to confirm or execute the protocol or the assistive communication layer 102 could automatically execute the following protocol, the assistive communication layer 102 may generate a new operational protocol or augment an existing operational protocol with steps to proactively initiate a request to the user on Tuesdays and at a specific hour to set up a meeting with the user and/or non-user. In setting up the meeting, the assistive communication layer 102 would typically execute a meeting scheduling operational protocol that requires the layer 102 to identify available times and dates on the user's calendar, identify a meeting location, and even contact the other user and/or non-user via one or more communication channels about scheduling the meeting.

Additionally, or alternatively, the assistive communication layer may determine, based on the identified one or more patterns, one or more operational protocols as a standard for initiating an interaction with the user and/or one or more non-users and execute the one or more standard operational protocols prior to or when one or more conditions associated with the identified patterns occur (e.g., it is Tuesday at a particular hour or immediately before then).

Regarding the knowledge acquisition unit 210 of the assistive communication layer 102, the knowledge acquisition unit 210 functions to acquire any type of data, either actively or passively (e.g., based on interactions or data collection in the background) from one or more users, one or more non-users, one or more external data sources, one or more communities or groups of users/non-users/entities, and community of applications.

Once the knowledge acquisition unit 210 acquires the data, the knowledge acquisition may store the data in the knowledge database no into one of a plurality of data buckets or sections in the database. For many purposes and embodiments herein, the data stored in the knowledge database no may be stored in primarily one of three data buckets or sections in the knowledge database. The plurality of data sections include a first data section relating to factual and/or data having a high degree of permanency (e.g., user birthday data, user sibling information, user home address, user name, and the like) and which generally does not change over time, a second data section relating to task specific data that is usually obtained in an interaction with a user and may be used for completing a task or work function by the layer 102, and a third data section relating to contextual data having varying degrees of permanency, but usually ephemeral in nature (e.g., present time, present location of user, and the like). This specific data organization structure allows for efficient data reference and acquisition by different task performing units of the assistive communication layer 102. For instance, the idea generator 240 may use contextual data in the third data section as raw input for an idea generation process.

It shall be noted that while it is generally preferred to organize data acquired by the assistive communication layer 102 using the knowledge acquisition unit 210 into the above-noted data section of the knowledge database 110, it is possible to include other data sections as the assistive communication layer 102 evolves to meet the needs of the user. Essentially, the assistive communication layer 102 may add new and/or different data sections or data classifying sections over time.

Additionally, the knowledge acquisition unit 102 may be used to acquire deep knowledge about one or more users of the system 100 and task knowledge for performing one or more tasks or work functions. In many cases, the deep knowledge acquired will be stored in the first data section and the task knowledge may be stored in the second data section of the knowledge database 110. In this regard, the knowledge acquisition unit 102 may gain knowledge and/or data directly from one or more users of the system 100, from a third party (e.g., external data source or external entity), from an acquaintance or a community of people or applications associated with the one or more users.

Accordingly, the knowledge acquisition unit 210 can be used to acquire task knowledge to complete a specific task (e.g., long running or short running task). The task knowledge is available both for completing a specific task and generally to the assistive communication layer agent 102, but can also be made anonymized and made available to the entire system 100 including other components of the assistive communication system 100 and other assistive communication layers. As an example, if an assistive communication layer 102 is working to coordinate a dinner party in Palo Alto, Calif. on Dec. 21, 2016, that task has context information (location, time, date) that can be relevant for other tasks immediately. If the task were related to finding a table for two for a date night, the knowledge of who the other party for the date (e.g., another user or non-user acquaintance of the user can be task knowledge for the immediate coordination, but the knowledge acquisition unit 210 may convert this task information as relevant context as to identify who the user's relationship partner may be. Further, the knowledge acquisition unit 210 learns the importance and type of the information as the information is used by other assistive communication layers (or sub-systems) of the assistive communication layer 102. Over time both automatically, through statistical techniques and through tagging the significant or key knowledge about a user is distinguished and highlighted as “Deep Knowledge”—i.e. information about a user that has significant relevance beyond mere usage in performance of a task.

As another example, frequency of visiting a specific restaurant by a user may elevate what is first considered by the assistive communication layer 102 as task knowledge into deep knowledge—simply by visiting the same restaurants frequently. Or across many different restaurant visits, knowledge that a user may be a vegetarian is gleaned and can be explicitly learned by the assistive communication layer. The conversion of task knowledge or sometimes ephemeral knowledge into deep or knowledge having a high degree of permanency may be accomplished by the knowledge acquisition unit 210 working to establish connections and/or links between data points within the knowledge database no. The above would example the passive workings of the knowledge acquisition unit 210 operating in a self-driving way to gain additional knowledge from or about the user, to confirm suspected beliefs relating to the user, rather than making assumptions with limited substantiation.

Explicitly, the knowledge acquisition unit 210 functions to directly gather deep knowledge from a user that will help the assistive communication layer and over system 100 perform with a high degree of relevancy in providing proactive tasks (e.g., assistive communication layer-initiated tasks). The knowledge acquisition unit 210, is therefore designed, in most embodiments, to gather more deep and task knowledge to improve the degree to which the assistive communication system can be assistive to the user because the more knowledge and context the assistive communication system 100 acquires, the better the system can personalize and properly work in the short, long, proactive and recurring tasks and generally all task types.

Additionally, the knowledge acquisition unit 210 can function to defer knowledge acquisition until a later time. As described above, there are different modes and manners in which the knowledge acquisition unit 210 may attempt to gather information. In some embodiments, the knowledge acquisition unit 210 gathers information a priori. In other instances, the knowledge acquisition unit 210 defers querying or asking questions of the user as far into the future as possible so that the user is always answering the minimum number of questions. Further, the knowledge acquisition unit 210 can acquire knowledge from third parties (APIs, phone calls, or other humans) meaning that the knowledge acquisition unit 210 may have a multi-stage process in which information is gathered from different sources, including one or more external data sources, in parallel or in a branching manner per the implications of the information gathered.

The one or more external data sources may include, but is not limited to, social media applications or feeds, weather feeds, traffic feeds, news, and the like. The one or more external data sources can be used by the knowledge acquisition unit 210 to provide assistive data that is useable by the assistive communication layer 102 for performing one or more operations or tasks based on an interaction with the one or more users and/or one or more non-users.

The knowledge acquisition unit 210 may also access shared data among disparate assistive communication layers of the system 100. Specifically, the user may interact with multiple assistive communication layers that may separately store data about the users (including interaction data). The data from the multiple assistive communication layers may be centralized and equally accessible to all assistive communication layers assisting the user and even other assistive communication layers assistive other, unrelated users.

Additionally, or alternatively, the knowledge acquisition unit 210 functions to acquire knowledge by interacting with a community of people and/or a community of applications. For instance, the community of people may be friends of the user that also use the system 100. The community of applications may be applications available or accessible via one or more user computing systems (e.g., mobile device, home and/or work computer, and the like). The applications may be any type of application including calendar applications, text messaging applications, social media applications, photo libraries or applications, financial applications and the like which the assistive communication layer 102 has been granted access to.

Accordingly, the knowledge acquisition unit 210 may aggregate data from a community of applications associated with the user. As an example, the knowledge acquisition unit 110 may have privileged access to one or more applications on the client computing device 150 of a user. In such example, the knowledge acquisition unit no is able to interact with the one or more applications to determine and collect useful data therefrom. In a specific example, the knowledge acquisition unit may identify a calendar application associated with a user and collect from the calendar application, the user's availability, scheduled meetings, and the like for the purpose of scheduling a lunch date with another user and/or non-user.

Additionally, the knowledge acquisition unit 210 may function to group similar questions (according to question similarity, response similarity and additional distance measures) and in doing so aims to reduce the number of questions that need to be asked to the user. This attribute of the knowledge acquisition unit 210 allows a reduction in a number of interactions with the user, a number of steps, barriers for the user to start with the assistive communication system 100, and effort required and speeds users towards task completion. As an example, if multiple assistive communication layers or agents need to know a user's home city, instead of asking the question multiple times with different framings, the knowledge acquisition unit 210 organizes the information and makes it available to all task flows of the disparate assistive communication layers.

Regarding identifying the types of knowledge that the knowledge acquisition unit 210 is required to learn/acquire, the knowledge acquisition unit 210 may be pre-programmed with predetermined sets of information (e.g., conditions) that are required to be satisfied for performing a task. These predetermined conditions can be fulfilled by one of many means including asking the user, relying on old information, having the assistive communication system 100 automatically re-confirm old information, asking other users in a task flow, asking a third party (e.g., an API), making a suggestion to the user. As a user interacts with the assistive communication system 100 the system may gather knowledge before the fact (before executing a task)—as required information or optional (to help guide the user) or after the fact—so that the assistive communication system can improve process or task flow in the future.

As an example of asking after the fact, the system 100 may want to gather information after it has completed a task (e.g., scheduling a 1:1 coffee meeting)—so that the system can learn or confirm an assumption. For instance, the assistive communication system 100 may inquire after completion of the task, “Is this your usual coffee sport?” or “Should we make this your default coffee meeting location?”.

The interaction interface unit 220 functions to provide an interface to a user and/or non-user that enables communication between the user and/or non-user and the assistive communication layer 102. The interaction interface unit 220 can establish an interface for interaction and/or use or integrate into an existing interface. The interaction interface unit 220 can be used to interface with one or more users and/or non-users via any communication channel accessible to the one or more users and/or non-users of the assistive communication system 100.

In a preferred embodiment, the interaction interface unit 220 may generate an agent representing the assistive communication layer 102 via a display or graphical user interface of a client computing device 150. The agent may be in the form of a person and/or an animated object shown on a display screen viewable by the user. The interaction interface unit 220 may similarly provide a voice or sounds to be associated with one or more functions of the assistive communication layer 102.

The interaction interface unit 220 may generate any form of display, acoustic, gesture, or other element for interacting with a user.

Additionally, or alternatively, the interaction interface unit 220 may generate one or more input elements, such as a keyboard, for receiving typed input from a user and/or non-user. Additionally, the interaction interface unit 220 may generate a selectable input interface that allows the user to interact with the assistive communication layer by making selections of one or more objects at the selectable input interface.

The analysis unit 230 functions to analyze an interaction with the one or more users and/or non-users and analyze data from various sources, such as external data sources. The analysis unit 230 may be implemented by one or more computer processors, which allow the analysis unit 230 to digest data input from the user to decipher a task or command request.

The analysis unit 230, in a preferred embodiment, implements a natural language processor that can interpret input from a user and/or non-user, whether the input is written, verbal, and/or gesture input.

The idea generator 240 functions to generate useful ideas and/or new ideas based on data in the knowledge database 120 and the one or more protocols in the operational protocol database no. The data from the knowledge database 120 and the operation protocol database 110 may be used as raw input in the idea generation process.

The idea generator 240 may generally function in two modes including a non-user request idea generation mode and a user-requested idea generation mode. In the first respective mode, the idea generator may be proactively (without human intervention or user request) identifying opportunities to generate ideas by cross-referencing data in the knowledge database 120 with the one or more protocols with the operational protocol database 110. In the second mode, the idea generator 240 may receive an explicit request from a user to generate an idea for task to be performed by the assistive communication layer 102 or simply a recommendation of one or more tasks that the user, herself, can perform.

The non-user request idea generation mode generally takes into account the user's immediate context (e.g., current time, current location, scheduled events for the day) together with the data in the knowledge database 120 and the protocols in determining an idea. Essentially, the immediate context of the user may be used to generate contextual parameters for limiting the data searched or that can be used in the knowledge database 120 and the protocols in the operational protocol database 110 that is considered by the idea generator 240 in the idea generation process. For example, based on contextual knowledge acquired by the knowledge acquisition unit 210, the idea generator 240 may know that it is 4:30 p.m., that the user is still at work, and a friend of the user is in close proximity to the user. In such case, the idea generator would use the contextual data to generator context constraints or parameters for cross-referencing the operational protocol database. In such example, the idea generator 240 would eliminate any lunch or breakfast scheduling protocols because it is 4:30 pm and breakfast and lunch time has passed and thus, the idea generator would limit its consideration to only protocols surrounding dinner scheduling or the like. Additionally, because the user is at work, the idea generator 240 will limit itself to operational protocols that allows it to schedule dinner at locations near the user's workplace. And lastly, since the idea generator 240 knows that the user's friend is in close proximity, the idea generator 240 will seek to identify an operational protocol for initiating a communication with the user's friend or with the friend's assistive communication layer agent in order to coordinate their schedules for a dinner meeting. Accordingly the idea generator 240 may suggest to the user scheduling dinner at a nearby restaurant with the friend that is in close proximity based on identifying the several operational protocols, as limited by the user's context.

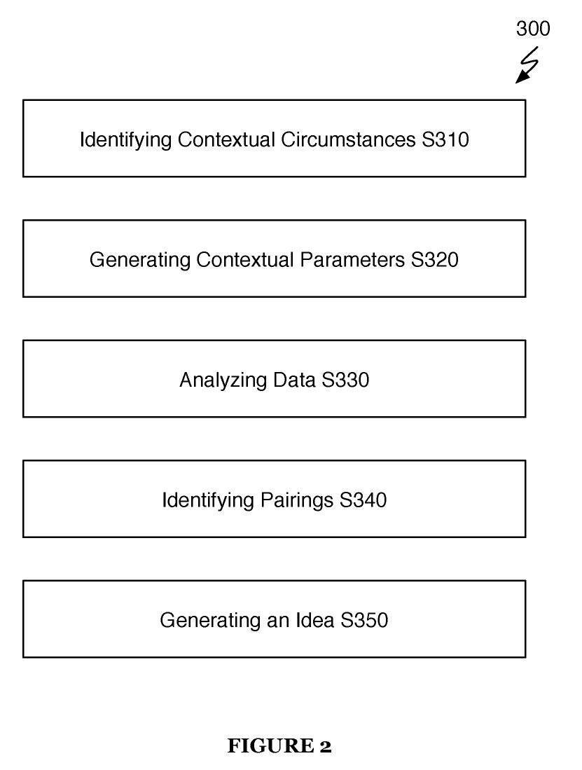

As shown in FIG. 2, a general process flow of a method 300 for generating one or more ideas by the idea generator 240 is provided. The method 300 includes identifying contextual circumstances relating to a user S310, generating contextual parameters based on the identified circumstances S320, analyzing data at the knowledge database S330, identifying pairings between data from the knowledge database and the operational protocol database S340, and generating an idea S350.

At step S310, the idea generator 240 leveraging the knowledge acquisition unit identifies one or more contextual data points regarding the user's circumstances from the knowledge database. Preferably the idea generator 240 also collects streaming data points related to a present time and current events and circumstances surrounding the user. For example, the idea generator 240 may identify a time of day associated with the user, a day of the week, user's location, and recent emails entering the user's inbox.

At step S320, the idea generator 240 generates one or more contextual parameters by converting the collected one or more contextual data points into contextual parameters that limit the data points in the knowledge database and protocols in the operation protocol database that are useable for generating an idea by the idea generator.

For example, if the user is working out of town, then the idea generator will eliminate from consideration any data points in the knowledge database that relates to tasks or work that can only be done in the user's city of residence. Similarly, this contextual data point may also eliminate any operational protocol strictly associated with performing work or tasks in the user's city of residence.

Accordingly, at step S330, the idea generator 240 restricted by the contextual parameters identifies and analyzes data in the knowledge database that share a connection with one or more of the contextual data points. For example, if a contextual data point is that it is currently 12:00 p.m. where the user is located, then the 12:00 p.m. data point may be associated with lunch actions usually taken by the user at that time. In such case, the idea generator 240 may identify several lunch-related data points in the knowledge database. Similarly, the idea generator 240 may identify several operational protocols that relate to lunch-related work or tasks.

To narrow down which data points and operational protocols that the idea generator 240 will use to form a new idea that idea generator 240 may implement a scoring and/or ranking system that receives contextual information as input and seeks to find a best fit with one or more data points in the knowledge database and/or one or more of the operational protocols that are within the constraints of the contextual parameters.

With respect to the one or more operational protocols, the scoring and/or ranking system weights the acceptance and non-acceptance of a prior idea, explicit user input about a prior idea, and the like.

The scoring and/or ranking system takes the knowledge and data about a user or group of users and seeks to provide the best set of operational protocols for the user or group of users given their current context. This algorithmic ranking system incorporates user/users past actions, the collective actions of users in similar past contexts as well as explicit signals from the user or users about the types of operational protocols that they want (or do not want). The explicit signals may be as simple as, a user has explicitly indicated that he/she wants more dinner reservation or evening time social activities. Or, potentially the explicit learning by the scoring and/or ranking system is that an individual restaurant is great. This can be applied both directly and in aggregate to the scoring such that similar ideas are presented. The scoring system primarily assists users in discovering new operational protocols and to repeat operational protocols the user likes. The scoring system, when using collective knowledge (e.g., data from other users), can group by similarity to this user—for example, parents like operational protocols 1, 2, 3 and since a specific user is a parent that may increase the score relating to operational protocols 1, 2, and 3. Additional similarities could be used but are not limited to location, profession, age, wealth, and the like of the user. Accordingly, any attribute describing the user that may be applied to a larger or global set of other users or people can be used.

At step S340, based on the scoring/rankings and/or analysis of data at the knowledge database, the assistive communication agent identifies pairings between data from the knowledge database and one or more operational protocols. The identified pairings are specific to the user and aid the idea generator by linking data relevant to the context of the user to one or more operational protocols that the user may find as useful or as good ideas for a task or activity to perform. The identified pairings may be used by the idea generator 240 make a leap to a new idea not present in the protocols or use one or more of the pairings as a bridge to a newly generated idea and associated newly generated protocols for implementing the idea.

Accordingly, the idea generated by the idea generator may be based on the existing of a pairing and the rank of the protocol in the identified pairing. Accordingly, the higher the score or rank of the protocol to the specific user, the more likely that the idea generator will use the highly ranking protocol to generate an idea. In some embodiments, the generated idea by the idea generator is the presentation of the task, activities, and/or capabilities associated with the highly ranking protocol. However, in a preferred embodiment, the generated idea is new and does not exist in the protocols although the generated idea is based on the highly ranking protocol. For instance, the protocol may be related a set of steps for scheduling dinner at a specific taco restaurant. The idea generator being aware of the context of the user knows that it is dinner time and that there is a new taco restaurant nearby. In such case, the idea generator will generate the idea for scheduling dinner at the new taco restaurant S350. The idea generator may similar generate new operational protocols for executing the scheduling at the new taco restaurant.

The idea generator 240 via the assistive communication agent may suggest the new idea to the user and the user can accept or decline the idea. The user's response will be stored in associated with the generated idea for various purposes including measuring a performance of the assistive communication/messaging agent and learning more about the user's preferences.

The co-browsing unit 250 functions to enable one or more users to monitor and/or view interactions between the assistive communication layer 102 and other users and/or non-users of the assistive communication system 100.

Specifically, the assistive communication system 100 functions to enable two or more users to interact while one or more users view and/or monitor the interaction between the assistive communication system 100 and one or more of the two or more users. Thus, allowing one or more monitoring users to co-browse or co-accomplishing a task with the help of the assistive communication system 100.

For example, if a user and another user are seeking a place for dinner, the assistive communication system 100 can coordinate between the two of the user but allow each of them to see the same information at the same time, provide input that is shared with the assistive communication system 100 and visible to all parties. This allows for enhanced collaboration and information gathering.

Essentially, by allowing the users to co-browse, the assistive communication system 100 can ensure that if several users are attempting to coordinate a task or event, that the different constraints or requirements of the several users are taking into account in coordinating the task or event (e.g., a first user can only meet after 4 pm, and a second user can only meet until 5 pm—that we the time of another user is not wasted and based on the constraints of the first two users, pointed and relevant questions can be asked to the third user to acquire relevant information for coordinating the meeting—(e.g., the assistive communication would inquire to the third user “are you free between 4-5 on Thursday?”—which otherwise we might have asked if the third user had availability from 4-8 pm.)

The training unit 260 of the assistive communication system 100 functions to train the assistive communication layer 102 based on knowledge and feedback from the user and/or non-user of the system.

The assistive communication system 100 using the knowledge acquisition unit 260 may gather information from users about whether the assistive communication layer 102 or system 100 is successful or could be improved. The training unit 260 typically provides a quick interaction for users to let the assistive communication system know if it is performing well.

This information acquired by the training unit 260 may lead to recommendations for the user based on similar user attributes across the assistive communication system, recommendations to all users of features and tasks to solve based on assistive communications system's quality, and the like.

Accordingly, the training unit 260 measures a performance of one or more components of the assistive communication system 100 and models the performance of the one or more components of the assistive communication system 100. Based on the modeling of the assistive communication system's performance, the recommendations are generated for one or more users and/or one or more non-users, based on the models, of capabilities of the assistive communication layer 102 or capabilities of other assistive communication layers that are available to be used by the one or more users.

The training unit 260 may measure various metrics relating to the efficiency of performance and an accuracy of performance of the assistive communication system 100. Regarding the efficiency of performance, the training unit 260 can measure an amount of time that an assistive communication layer utilizes to perform one or more tasks and work functions. For instance, the training unit 260 may measure a time of performance beginning from the initial request made by a user and if the task or work is initiated by the assistive communication layer, the training unit 260 measures from a time beginning when the assistive communication layer engages the user regarding performing the task or work. The training unit 260 may stop the measure of time when there is an indication by the assistive communication system or by the user that the task or work is complete.

With respect to the accuracy of performance, the training unit 260 may measure an accuracy of performance of work based on multiple factors including whether the performance of the work or task was accepted by the user and whether there was an express indication of accuracy by the user.

In terms of modeling the performances of the assistive communication system, the training unit 260 is able to generate various statistical models and other graphical representations or in some instances, simply provide scoring information or values without graphical representations of the models.

The operational protocol database no of the assistive communication system 100 functions to store and manage one or more operational protocols. The operational protocol database no may classify each of the operational protocols and store each of the protocols based on their classification. Additionally, the operation protocol database no may store related or those protocols identified in the same classification together. For instance, the operational database 110 may classify a set of protocols under a lunch scheduling category, another set of protocols under a parenting coordination category, another set of protocols under an automatic communication category, and yet another set under a work template generation category, and the like. Thus, each of these categories may include several protocols for performing tasks or work related to the category type. This categorization allows for the assistive communication layer 102 to easily identify one or more subsets of protocols for performing a work or task. Additionally, the category names and types may be changed and more categories can be added or removed over time based on interactions between the assistive communication system and the user. The naming convention of the categories or classifications of the one or more protocols may also allow for ease of identification by an assistive communication layer, in that, the assistive communication layer may be able to identify one or more key terms, key conditions (wherein condition relates to a user's context) in a request from a user and correspond or match one or more of the key terms to a category name.

Additionally, or alternatively, each protocol may be associated or linked to a set of metadata and that the metadata of the protocols can be updated to improve and ease the identification by an assistive communication layer and/or human.

Each of the one or more operational protocols stored and managed by the operational protocol database 110 includes one or more steps and/or a predetermined algorithm to accomplish a specific task or work function. Each of the one or more operational protocols may also include one or more conditions for triggering the execution of the one or more steps and/or predetermined algorithms. It shall be noted that while many of the one or more operational protocols may initially be predefined by a developer or the like, the one or more operational protocols may be changed or deleted and therefore, in some instances are dynamic.

For instance, in some embodiments, the one or more steps or predetermined algorithm of a protocol can be updated or rewritten to include or remove at least one step or is updated to modify the predetermined algorithm based on interaction sessions with a user and/or information acquired by the knowledge acquisition unit. Thus, the one or more operational protocols can be modified by the assistive communication layer 102 or system 100 to be more custom according to methods and/or preference of a user.

Additionally, operational protocols can be added to the operational database 110 to take into account new capabilities of an assistive communication layer or user-requested functionality or deleted due to obsolescence.

The assistive communication server 140 functions to implement the assistive communication layer 102 and/or various other components of the system 100. The assistive communication server 140 generally includes one or more computer processors and/or controllers 141, a deductive unit 142, and a communication interface 143, and other known components of a server.

The assistive communication server 140 controls to operate the various functionalities of the assistive communication layer 102 including the interactions with the one or more users, non-users, and entities and, the interaction of the assistive communication layer with other components of the system 100.

The deductive unit 142 of the assistive communication server 140 functions to deduce or infer additional knowledge and/or additional context relating to the user. Further, the deductive unit 142 stores the additional knowledge and additional context in the knowledge database 120 and if related, the additional knowledge and additional context are stored in association. Generally, the deductive unit 142 functions passively to establish links between data points in the knowledge database 120 and using those links to make inferences and deductions. However, in some instances, the deductive unit 142 of the server 140 may be actively engaged by the assistive communication layer 102 or other components of the assistive communication system 100 for assistance.

As an example, based on a scan of the knowledge database 120, the deductive may know that a user and second user are co-workers, and may also know that the employer of the second user. While the user may not have indicated at any point to the assistive communication system 100 his employer, the deductive unit 142 may link the two data points, noted above, and deduce or infer that because the user and the second user are co-workers and that the second user is employed by company X, that the user must also be employed by company X. At a later or relevant time, the deductive unit 142 via the assistive communication layer 102 may confirm this inference by inquiring with the user about the accuracy of the inference. Once the inference is confirmed or if the deductive unit 142 is confident regarding the inference, the deduced additional knowledge may then be stored at the knowledge database 110 and become another known data point about the user, which can be used in performing one or more work functions or tasks.

In some embodiments, in an attempt to perform a work function or task by the assistive communication layer 102, it may be determined that some information that may be critical to completing the work function or task is missing or not included in the knowledge database 110. In such embodiment, rather than immediately inquiring with the user or other user/non-user, the knowledge acquisition unit 210 may request assistance from the deductive unit 142 for determining or deducing the missing information (e.g., who is the user's employer?). Accordingly, the deductive unit 142 may then re-prioritize its tasks to first perform the active request for assistance rather than performing the passive deductions and inferences (e.g., passive workflow).

In the active workflow mode, the deductive unit 142 would make the links between the data points in the knowledge database and infer that the user's employer is company X, as previously exampled above. The deductive unit 142 would then communicate the inference to the assistive communication layer 102 and the layer may later confirm the inferred knowledge with the user. Contrarily, if the deductive unit 142 is not able to infer the requested information, the deductive unit 142 would revert to the assistive communication layer 102 with a negative response.

As another example of performing an inference, if the deductive unit 142 is aware of a location of a user, as well as a scheduled meeting on the user's electronic calendar, and also has determined a travel time from the user's location to the schedule meeting location, the deductive unit 142 in such example may infer that the user cannot arrive to the scheduled meeting at the scheduled time. In such example, the deductive unit 142 may inform the assistive communication layer 102, which would then tailor the ideas and set of tasks to potentially be preformed to the context of the user, for example, knowing now that the calendar is not an accurate representation of the user's future location, the assistive communication system may promote a task to coordinate a dinner meeting with colleagues in the user's current area rather than the location suggested by the calendar. The assistive communication layer 102 would then identify an appropriate protocol to execute which allows the assistive communication layer to identify the relevant business colleagues that are in the area, collect their availability and location information directly or indirectly and additionally send communication, such as a SMS text message, email, or call inquiring about the business dinner meeting opportunity.

Additionally, in the case that an ambiguity arises regarding a potential inference by the deductive unit 142 (e.g., the user's co-worker has two jobs), the occurrence of the ambiguity may trigger the deductive unit 142 to inquire and/or prompt the user to resolve the ambiguity via a knowledge acquisition unit.

The client computing device 150 may be any computing device (e.g., mobile phone, tablet, desktop computer, smart watch, vehicle, and the like) or commandable browser that is owned, maintained, or otherwise accessible to the user for implementing part of the system 100. In some embodiments, the client computing device 150 functions to implement some or aspects of the communication layer 102.

The client computing device may include one or more processors, a display, a communication interface, commandable browser input/output components, a timer, and other known components.

The assistive community 160 includes a plurality of data sources available to the assistive communication layer 102. The assistive community 160 functions as a data resource to the assistive communication system 100 and layer 102. The assistive communication layer 102 in performing a task or work function may be able to acquire task specific knowledge for accomplishing the task or work function. Similarly, the assistive communication layer 102 may acquire other knowledge about the community in general that may assist the layer 102 to further assist a user.

For example, the assistive community 260 may be a group of people or users of the assistive communication system 100. The assistive communication layer 102 may leverage the information acquired about the community by the system 100 to identify similar users and/or users that may be similar (potentially geographically, potentially age, gender, education, profession, marital status and with or without children). This information may allow the assistive communication layer 102 to generate ideas and/or recommendations for the user. Or, in some cases, provide additional knowledge to allow the assistive communication layer to perform a task or work function for the user.

In another example, the assistive community 260 may be a combination of external data sources and user applications. The assistive communication layer 102 may subscribe to feeds of the external data sources or otherwise, be able to scan data associated therewith. With respect to the user application, the assistive communication layer 102 may be able to scan the software applications, such as a calendar application, text message application, email application, and the like and acquire knowledge via the acquisition processes of the knowledge acquisition unit 210.

### 2.A Method Implementing an Assistive Communication Layer

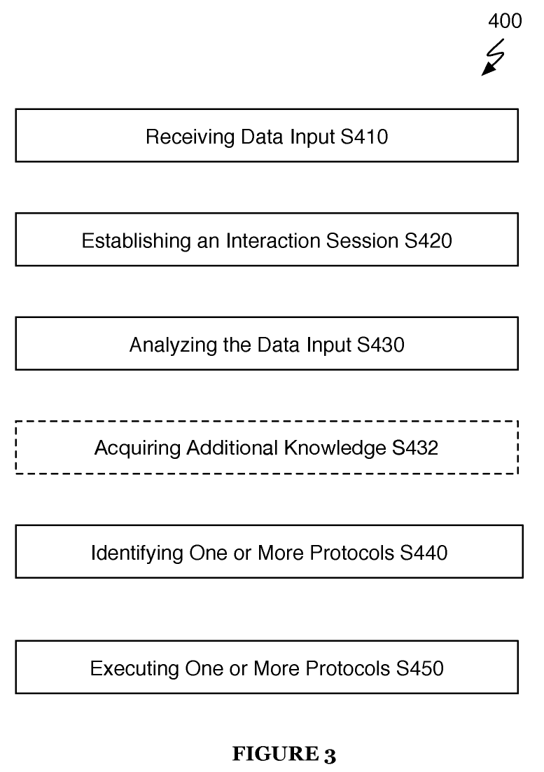

As shown in FIG. 3, a general process flow of a method 400 for implementing an assistive communication layer is described. The method 400 includes receiving data input from one or more users and/or non-users S410, establishing an interaction session between the user and/or non-user and the assistive communication layer S420, analyzing the data input S430, identifying one or more operational protocols to execute S440, and executing the one or more protocols S450. The method 400 optionally includes acquiring additional knowledge S432.

The method 400 functions to enable an assistive interaction between an assistive communication system and/or assistive communication agent and a user and/or non-user.

At step S410, data input from a user is received via the assistive communication agent. The data input may be communicated by the user in any manner including using text input, verbal input, using gestures, or some other pre-negotiated technique between the user and the assistive communication agent. The data input may be a question, a statement of fact or opinion, a request or command for work or a task to be completed, and the like.

Additionally, or alternatively, the assistive communication agent may initiate communication with the user and thus, the data input by the user may be in response to the initial communication from the assistive communication agent.

At step S420, the reception of the data input from the user may then be used to trigger or establish an interaction session between the user and the assistive communication agent. The establishment of the interaction session may trigger one or more components of the assistive communication system to redirect their workflows to an active state from a passive state, which would allow for greater response times and quality of response to the user's data input. Additionally, the establishment of the interaction session triggers the beginning of various metrics that are measured by a training unit and also, one or more knowledge acquisition processes of a knowledge acquisition unit.

At step S430, the data input may be analyzed using one or more processors including a natural language processor to decipher the intended communication or request of the user. The data input may be analyzed to determine the data input type including whether the data input is a request, a command, a conversational statement, opinion, and the like. The analysis of the data input also identifies one or more key terms that can be used to identify relevant data in the knowledge database no and/or to identify one or more operational protocols to execute in response to the data input.

At step S432, responsive to the analysis of the communication and/or data input and prior to the identification of the one or more operational protocols, the assistive communication agent may determine that additional knowledge is required and in that case, the knowledge acquisition unit may be used to acquire additional knowledge from the knowledge database and/or one or more external data sources related to the communication and/or data input.

In some embodiments, part of the one or more protocols define a set of conditions that when met will automatically trigger the assistive communication layer 102 to execute a task or work. Accordingly, the identified operational protocol includes one or more conditions that, when satisfied, triggers an implementation of at least one of the one or more steps or at least part of the predetermined algorithm of the identified operational protocol.

As an example, if the assistive communication agent is tasked to coordinate between four friends to do a dinner, the assistive communication agent may have the condition that once a person replies, others are prompted to reply again and given the updated information of the best times for the group. Or, if all four people need to get together but the suggested times do not work for one of the people, instead of determining which times work for the remaining three people, the assistive communication agent would stop doing knowledge acquisition around the originally proposed times, and instead restart around the condition of finding tentative times that could work for all four people.

A condition or a condition set may be any predetermined and/or user-defined conditions. Conditions may include, but are not limited to, time or date, specific date and time, an occurrence of an event, acquiring a certain piece of information, a set amount of time after a specific condition was met (e.g., one week after a meeting), when a logical relationship is satisfied (e.g., when price of gold is >X, when the temperature is <Y, a repeating condition, and the like).

Additionally, if any of the one or more conditions fail, the assistive communication agent may identify one or more alternative operational protocols to execute or executing one or more alternative steps or a modified algorithm.

In some embodiments, the one or more conditions are determined from the analysis of the communication and/or data input from the one or more users. Additionally, the data from the interaction session and the one or more conditions may be stored in association with each other at the knowledge database thereby allowing for a quick reference by the assistive communication agent in the case that a similar or same communication and/or data input is made by the user.

At step S440, based on the analysis of the data input, the assistive communication agent identifies one or more operational protocols to execute to effectively respond to the data input. In some instances, if the data input is a simple request, the assistive communication agent may bypass the operational protocols and simply respond using a standard or predetermined response protocol.

Additionally, as a result of the analysis, one or more key terms and associations may be determined that may be useful in identifying useful data in the knowledge database and/or for identifying the one or more operational protocols to execute. Essentially, the key terms may be used as search terms by the assistive communication agent to identify operational protocols in the operational protocol database having matches to the key terms. A similar operation may be performed with the knowledge database.

At step S450, once one or more operational protocols are identified, the assistive communication agent executes the operational protocols to thereby provide a response to the user.

With respect to doing work (e.g., the execution of the one or more protocols), the assistive communication agent is able to tackle tasks in multiple formats including, working immediately, working in a long running format, working in a recurring/repeating format, working in a proactive format, working in multiple disparate steps that are not a continuous flow.

In the case of performing work having disparate steps and not in a continuous flow, the one or more steps of an operational protocol for performing the work or disparate parts of the predetermined algorithm for performing the work of the operational protocol may be executed in a discontinuous manner such that a first step or first part is performed during a first period of time and another step or another part is performed at another non-overlapping and discontinuous period of time.

The non-overlapping and discontinuous period of time relates to one of a smart time period and a waiting time period, wherein the smart time relates to an optimal time to interact with the one or more users and/or one or more non-users.

Regarding performing an immediate task by the assistive communication agent, an immediate task may one that can or is performed within moments of an interaction or request from the user. As an example, a user may interact with the assistive communication agent to work on determining if one (or more) of the user's acquaintances is available for dinner during a present evening (e.g., today). Here the ACS will communicate on behalf of the user with the user's acquaintance and then follow-up with the user to keep the user informed of the progress in performing the requested task.

A long running task may be tasks in which the assistive communication agent is provided a set of parameters that the assistive communication agent will work to accomplish the set of parameters over time (e.g., several days, weeks, or months) wherein the period of time is a definitive period of time or indefinite period of time.

Near completion of a task, when the assistive communication agent believes that it has discovered an element that satisfies the conditions of the task or work requested, it can ask the user if the delivered option completes the task. If not, the assistive communication agent learns further about the conditions and continues working.

Regarding proactive tasks, the assistive communication agent based on knowledge acquired by the knowledge acquisition unit, the assistive communication agent determines that a user may need performing a work function or task. The one or more operational protocols and conditions that trigger the proactive tasks by the assistive communication agent may be expressly defined or loosely/impliedly defined.

For example, the user may have an acquaintance with an upcoming birthday and thus, the condition for the possible work of acquiring a gift is expressly defined by the condition of the upcoming birthday. Alternatively, the conditions may be more loosely defined and a proactive task may be started and then check-in work with the user may happen (e.g., knowledge acquisition) to determine if the task should be continued. As the user provides information, the set of proactive tasks will adjust to best match both the user's preferences in completing the task but also the user's preferences in proactive tasks.

The assistive communication agent, on its own accord, may also elect to repeat tasks or have certain tasks recur. As an example, on a recurring basis, the user goes attends a meal with an acquaintance. In such case, instead of the assistive communication agent completing a reservation for the user once, the assistive communication agent may establish an operational protocol for the routine work of acquiring a reservation for the user for every Friday or so. The work or task of coordinating the reservation and schedule of the user and the acquaintance may be completed entirely autonomously and without the user's intervention. The result will be that only completed reservation will be presented to the user and subsequently, collecting feedback directly and/or indirectly based on actions of the user. Alternately, the assistive communication agent may use the knowledge acquisition unit to acquire most recent information from the user on a regularly schedule to complete the desired tasks of scheduling the reservation and coordinating schedules.

The method of the preferred embodiment and variations thereof can be embodied and/or implemented at least in part as a machine configured to receive a computer-readable medium storing computer-readable instructions. The instructions are preferably executed by computer-executable components preferably integrated with autonomous vehicles. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

We claim:

1. An assistive communication system, the system comprising:
an operational protocol database comprising a plurality of operational protocols for implementing one or more tasks associated with one or more interactions involving the assistive communication system and one or more users and/or one or more non-users and/or one or more non-users;
a knowledge database comprising data obtained based on the one or more interactions involving the assistive communication system and the one or more users and/or one or more non-users;
an assistive communication layer having:
a knowledge acquisition unit that acquires data from one or more sources and interactions involving the assistive communication system and the one or more users and/or one or more non-users over disparate periods of time;
an interaction interface that is configured to act as an input and/or communication interface for allowing the one or more users and/or one or more non-users to interact with the assistive communication system;
an analysis unit that analyzes communications and/or inputs from the one or more users during the one or more interactions;
wherein, at the assistive communication layer:
receiving a communication and/or data input from the one or more users and/or one or more non-users;
establishing an interaction session between the one or more users and/or one or more non-users and the assistive communication system based on the communication and/or data input;
analyzing the communication and/or data input from the one or more users and/or one or more non-users; and
responsive to the analysis of the communication and/or data input, (i) referencing the knowledge database for data relevant to the analysis and (ii) identifying one of the plurality of operational protocols to execute.

2. The system of claim 1, wherein the knowledge acquisition unit is further configured to acquire data from (i) one or more external data sources, (ii) shared data among disparate assistive communication layers within the assistive communication system, (iii) a community of people, and (iv) a community of applications associated with the one or more users and/or one or more non-users,
wherein the one or more external data sources provide assistive data to the assistive communication layer that is useable for performing one or more operations or tasks based on an interaction with the one or more users and/or one or more non-users.

3. The system of claim 2, wherein further responsive to the analysis of the communication and/or data input and prior to the identification of the operational protocol, using the knowledge acquisition unit to acquire additional knowledge from one or more external data sources related to the communication and/or data input.

4. The system of claim 1, wherein each of the operational protocols includes one or more steps or a predetermined algorithm to accomplish a specific task.

5. The system of claim 4, wherein one or more steps or predetermined algorithm of the identified protocol is updated or rewritten to include or remove at least one step or is updated to modify the predetermined algorithm based on the interaction session.

6. The system of claim 4, wherein the identified operational protocol includes one or more conditions that, when satisfied, triggers an implementation of at least one of the one or more steps or at least part of the predetermined algorithm of the identified operational protocol.

7. The system of claim 6, wherein if any of the one or more conditions fail, identifying an alternative operational protocol to execute or executing one or more alternative steps or modified algorithm.

8. The system of claim 6, wherein the one or more conditions are determined from the analysis of the communication and/or data input from the one or more users and/or one or more non-users.

9. The system of claim 8, wherein data from the interaction session and the one or more conditions are stored in association at the knowledge database.

10. The system of claim 6, wherein steps of the identified operational protocol or disparate parts of the predetermined algorithm of the identified operational protocol are executed in a discontinuous manner such that a first step or first part is performed during a first period of time and another step or another part is performed at another non-overlapping and discontinuous period of time. ii. The system of claim ii, wherein the non-overlapping and discontinuous period of time relates to one of a smart time period and a waiting time period, wherein the smart time relates to an optimal time to interact with the one or more users and/or one or more non-users.

12. The system of claim 1, wherein, at the assistive communication server:
responsive to the interaction session, linking data acquired at the knowledge acquisition unit to at least one operational protocol of the plurality of operational protocols.

13. The system of claim 1, further comprising:
a natural language processor that converts, during an interaction with the one or more users and/or one or more non-users, natural language input from the one or more users and/or one or more non-users into computer-comprehensible input.

14. The system of claim 1, where, at the knowledge acquisition unit:
responsive to the analysis of the communication and/or data input, (i) identifying one or more queries relating to additional information required for performing a task by the assistive communication system, (ii) prompting the user with the one or more queries to obtain the additional information; and
using the additional information to identify the operational protocol or to modify the identified operational protocol prior to execution.

15. The system of claim 1, further comprising:
a co-browsing unit that:
enables two or more users to interact with the assistive communication system contemporaneously or at a same time such that the two or more users view communications and/or data input to the assistive communication system by either of the two or more users,
or
enables one or more users and/or one or more non-users to view an interaction between the assistance communication system and at least one other user.

16. The system of claim 1, further comprising:
an assistive communication server that implements the assistive communication layer, wherein the assistive communication server comprises a deductive unit that is configured to infer knowledge or data based on data in the knowledge database and/or acquired by the knowledge acquisition unit.

17. The system of claim 1, wherein the assistive communication layer identifies contextual parameters based on the data in the knowledge database and/or acquired by the knowledge acquisition unit, the contextual parameters defining circumstances of the one or more users that is useable to automatically identify one or more operational protocols of the assistive communication layer to be executed.

18. The system of claim 1, wherein each of the plurality of operational protocols is associated with one or more predetermined capabilities of the assistance communication layer,
the assistive communication system further comprising:
a second assistive communication layer that provides assistance to the one or more users for determining which of the one or more predetermined capabilities of the assistive communication or other assistive communication layer that the one or more users should use and enables interfacing with the other assistive communication layers of the assistive communication system.

19. The system of claim 1, further comprising:
a third assistive communication layer that:
collects, from one or more data sources, one or more requirements and/or concepts for additional capabilities for a new or existing assistive communication layer to be generated.

20. The system of claim 1, further comprising:
a fourth assistive communication layer that:
measures a performance of one or more components of the assistive communication system;
models the performance of the one or more components of the assistance communication system; and
generates recommendations for the one or more users and/or one or more non-users, based on the models, of capabilities of the assistive communication layer or capabilities of other assistive communication layers that are available to be used by the one or more users.

21. The system of claim 1, wherein the assistive communication layer further:
identifies one or more patterns relating to an interaction method of the one or more users and/or one or more non-users of the assistive communication system; and
determines, based on the identified one or more patterns, one or more operational protocols for interacting with the one or more users and/or one or more non-users.

22. The system of claim 1, wherein the assistive communication layer further comprises:
an idea generation unit that:
identifies contextual circumstances relating to the one or more users;
generating contextual parameters based on the identified contextual circumstances, wherein the contextual parameters define a subset of data in the knowledge database and a subset of operational protocols in the operational protocol database;
analyzes the subset of data at the knowledge database and the subset of operational protocols; and
generating an idea comprising a task or activity based on the analysis of the subset of data and the subset of operational protocols.

23. A method for implementing an assistive communication layer, the method comprising:
at an assistive communication layer:
receiving a communication and/or data input from one or more users and/or one or more non-users;
establishing an interaction session between the one or more users and/or one or more non-users and the assistive communication layer based on the communication and/or data input from the one or more users and/or one or more non-users;
analyzing the communication and/or data input from the one or more users and/or one or more non-users; and
responsive to the analysis of the communication and/or data input, (i) referencing a knowledge database for data relevant to the analysis and (ii) identifying one of a plurality of operational protocols to execute.
